(19) United States
(12) Patent Application Publication
(10) Pub. No.: US 2002/0099667 A1
(43) Pub. Date: Jul. 25, 2002

(54) Mehtod and apparatus for making purchases over the internet using pre-paid cards

(76) Inventors: Peter H. Diamandis, Pasadena, CA (US); Marc A. Samson, Santa Monica, CA (US); Dezso Molnar, Pasadena, CA (US); Gary Gumowitz, New York, NY (US); Jonathan Lynn, New York, NY (US)

Correspondence Address: Banner & Witcoff, Ltd., Elevneth Floor, 1001 G Street, N.W., Washington, DC, 20001-4597, US

(21) Appl. No.: 09/767,151

(22) Filed: Jan. 23, 2001

(51) Int. Cl. G06F 17/60; H04K 1/00; H04L 9/00

(52) U.S. Cl. 705/74; 705/78; 705/65; 705/64

(57) ABSTRACT

The invention provides a system and method for facilitating transactions over the Internet using pre-paid cards, such as pre-paid telephone cards. A third-party phone-card payment facilitator represents that it will coordinate payment to vendor web sites for on-line customer purchases with the value of pre-paid phone cards. The vendor's web site operator posts a branded logo from the third party phone-card payment facilitation web site, which is linked to the database of phone card value and verification process operated by the phone card manufacturer or sponsor. The link allows the customer to verify from the third-party phone-card payment facilitation web site that the vendor's web site is in cooperation with certain phone card manufacturers and can be utilized to make a purchase against the current value of the customer's pre-paid phone card. A customer who owns an anonymous pre-paid phone card can purchase goods, services or information from a web site using existing phone card telephony infrastructure. In addition to anonymity, the system and method provides financial security to customers, who need not risk entrusting their creditworthiness to unknown web site operators.

### BACKGROUND OF THE INVENTION

1. Technical Field

This invention relates generally to electronic commerce and the Internet. More particularly, the invention provides a method and apparatus that allows consumers to purchase information, goods, and services by utilizing pre-paid debit cards such as those used by the telephone industry.

2. Related Information

Many Internet web site providers charge a fee to consumers in exchange for the opportunity to view and hear the information available on their web site. Web sites commonly sell information about employment opportunities, available housing and rentals, adult entertainment, dating services, music, and video, in exchange for one-time or weekly/monthly/annual membership fees. Currently there are three major online payment options for purchasing such information or memberships: credit cards, checks (sent electronically), or the use of “900” telephone numbers that apply charges to the consumer's telephone bill. Though inherently insecure, these options have proven to be generally reliable when implemented by honest web retailers. However, use of any of these methods may expose the consumer to illegal acts practiced by some online retailers of overcharging the consumer and/or continuing to charge the consumer for memberships even after cancellation. The financial exposure to a consumer is great because a web site operator can bill consumers to the limits of their credit cards, checking accounts, or telephone credit.

In addition to unethical billing practices, consumers must often contend with the problems of privacy and financial history violations. The three billing options mentioned above require that consumers disclose personal and financial information that can be used without the consent of the consumer.

If a person does not own a credit card, checking account, or billable phone service contract, they cannot currently purchase online information in most instances, even though they may be able to produce sufficient cash for the transaction.

The lack of consumer confidence in online billing practices and discrimination against consumers who lack credit has had a dampening effect on e-commerce growth and acceptance.

Two recent schemes that attempt to mitigate some of these problems are the VISA BUXX card and the HUSTLER GOCARD. The BUXX card provides a method for teenagers to learn credit card spending habits. As such, it limits the amount of money that can be spent using the card to the amount of funds that have been allocated in advance to a dedicated account for retail and online purchases. The BUXX card utilizes the VISA credit card billing system. Similarly, the GOCARD is a pre-paid card that permits the owner to purchase memberships to Hustler Corporation adult entertainment websites. To make a purchase, the customer must go directly to the pre-authorized website and input the PIN on the card to gain access to the website. This is an internal verification system at Flynt Publishing. Neither of these methods can be used with pre-paid telephone cards, which are anonymous in nature and disposable after use. Accordingly, they do not fill the need for consumers who seek an anonymous, financially secure, and widely accepted technique for making purchases over the Internet.

### SUMMARY OF THE INVENTION

The present invention overcomes the aforementioned problems by providing a method and apparatus for consumers to anonymously purchase information, goods, and services over the Internet by applying the same pre-paid debit cards utilized by the telephone industry (so-called “phone cards”) to Internet commerce. With this invention, phone card owners will be empowered to make online purchases, without exposing their credit history or risking charges beyond the value of their pre-paid card.

In various embodiments, a third party website represents that it will facilitate an exchange for value of a phone card for access to Internet distributed information, goods, or services from a chosen web site. The chosen web site operator posts a branded logo from the third party facilitator on the web site, which is linked to a web site operated by the third party facilitator. The link enables the consumer to input a card identifier and value information, and the unique personal identification number (PIN) of their phone card into a website database. This information is forwarded to the phone card manufacturer and checked through a conventional phone card verification process. A transaction with the consumer's chosen website is then authorized on the basis of the verification process, and the value of the transaction is charged against the phone card. Once the consumer's PIN is verified, the consumer can receive a user identification name and password, authorizing the sale and/or membership privileges to their chosen web site, or can consummate a purchase in any other conventional way. The purchase transaction sets in motion a payment transaction from the phone card manufacturer to the Internet website for services and to the facilitating website from either or both parties.

In accordance with one aspect of the invention, any consumer who currently owns a valid phone card, or is able to purchase one, is able to make online purchases utilizing the existing and future versions of the phone card and telephone industry's crediting and debiting infrastructures. The invention provides a system and process that enables a consumer's Internet purchase request to interface with a phone card billing system in a way that provides anonymity and limited financial risk to the consumer.

Other features and advantages of the invention will become apparent with reference to the following detailed descriptions and figures.

### BRIEF DESCRIPTION OF THE DRAWINGS

FIG. 1 shows a vendor's web site 100 constituting an on-line entertainment site including a phone-card payment facilitator's logo 102.

FIG. 2 shows a third party phone-card payment facilitating web page for selling goods and services that can be accessed by clicking on the phone card payment representation logo 102 of FIG. 1.

FIG. 3 shows an Internet payment form that can be filled at the third party phone-card payment facilitator's web site to request a transfer of funds from a phone card to a vendor's website to complete a purchase.

FIG. 4 shows a system including a customer's computer 401, a plurality of vendor sites 402 and 403, and a phone-card payment facilitator's site 404.

FIG. 5 shows a method incorporating various aspects of the present invention.

FIG. 6 shows details of a purchase verification process using a telephony platform.

### DETAILED DESCRIPTION OF THE PREFERRED EMBODIMENTS

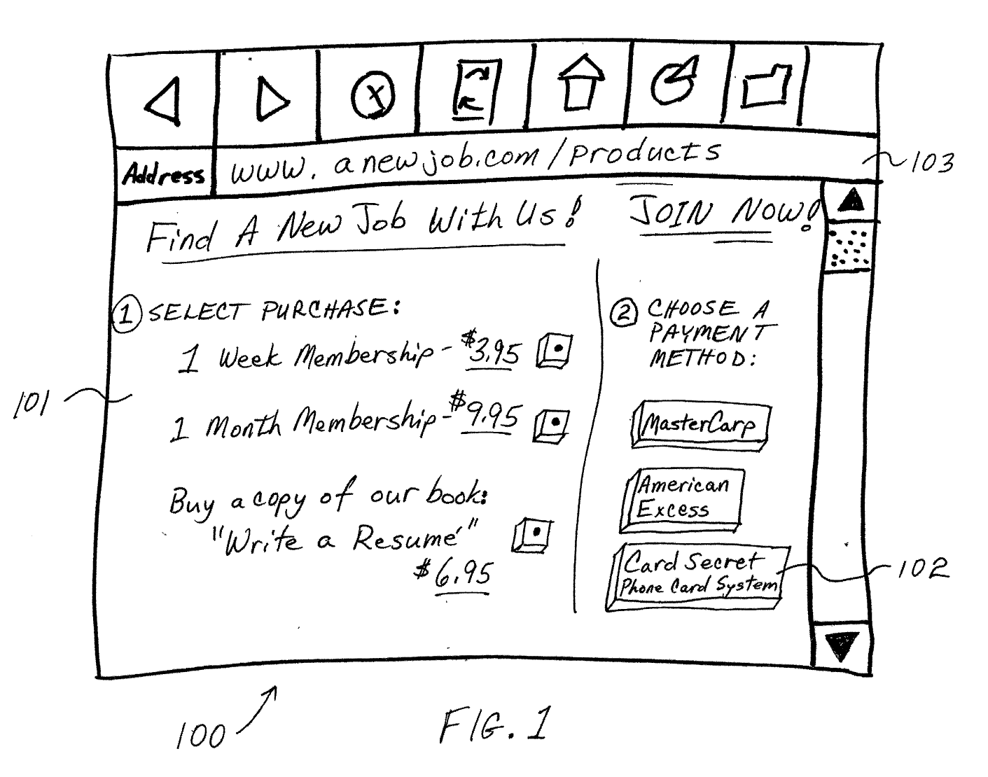

FIG. 1 shows a vendor's web site 100 as seen through a conventional web browser, including an address bar 103 indicating the address of the vendor's site. In the example of FIG. 1, the web site (“A New Job”, residing at www.anewjob.com) offers a variety of products, text, pictures, video clips, and audio clips to a customer. Site-specific content 101 describes available information for the customer and permits the customer to purchase a membership for access to this web site's content or products. It will be appreciated that a variety of goods and/or services can be purchased at the web site as is conventional. The term “web site” refers to a computer on which a web page is stored and from which the page can be retrieved by a web browser.

Web site 100 also includes a phone-card payment facilitator's logo 102 that identifies a third-party that has agreed to authorize phone card usage as a payment mechanism for goods, services, and/or information through the vendor's web site. In various embodiments, the phone-card payment facilitator's logo 102 may be posted on the vendor's site only by agreement between the vendor and the third party phone-card payment facilitator. In one embodiment, the phone-card payment facilitator's logo permits the customer to immediately navigate to a web site operated by the third party phone-card payment facilitator in order to input the secured information provided by a phone card to complete a financial transaction.

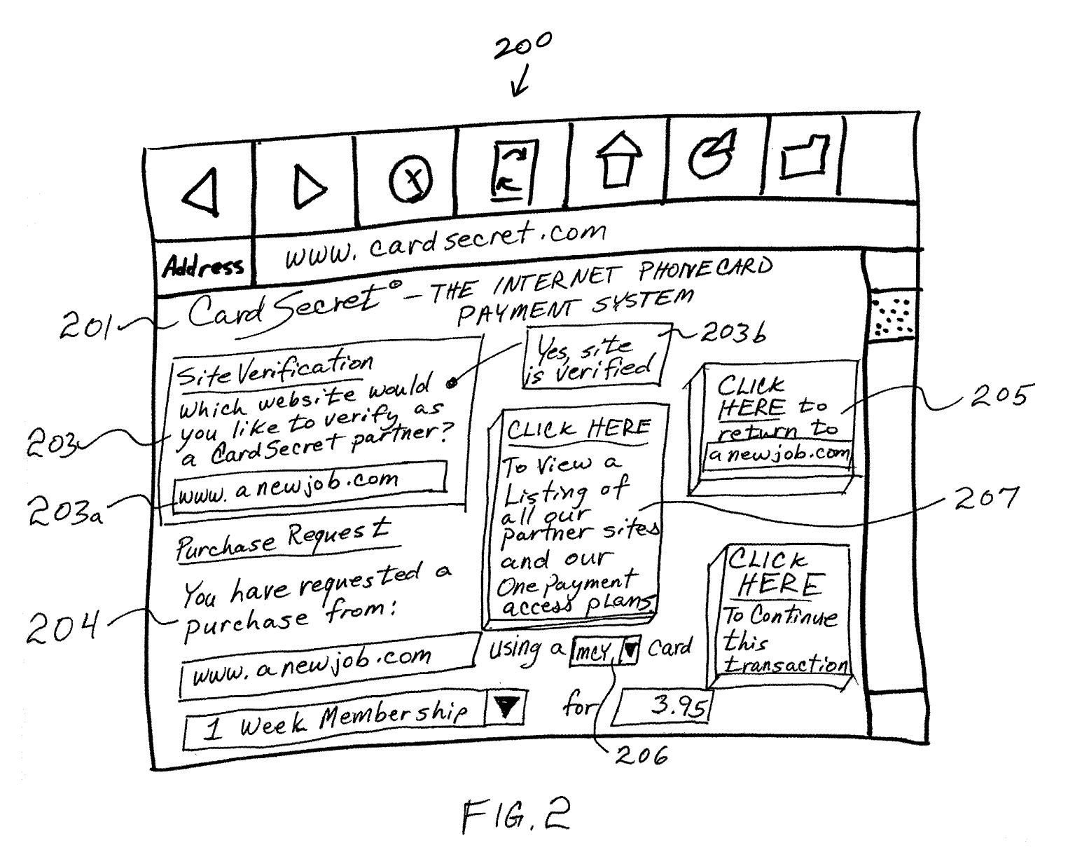

Turning now to FIG. 2, it is assumed that a customer has clicked on the phone card payment representation logo 102 of FIG. 1 and is directed by way of a hyperlink to a web site 200 operated by a third party phone-card payment facilitator as specified in the address bar 202. At this web site, a site verification function 203 permits the customer to verify that the vendor's web site participates in the billing program, and that the customer may feel confident in making a transaction with the phone-card payment facilitator for access to that web site. Additionally, the customer can view the names of other participating web sites and purchase offers 207.

In one embodiment, the customer can manually enter the web site address into a text box 203a; alternatively, the text box could be pre-populated with the name of the web site from which the customer was transported. When the user enters the name of the vendor site, a message 203b is displayed that confirms that the vendor web site participates in the billing program. It will be appreciated that other methods of providing site verification can be performed; for example, a message could be generated immediately upon navigating to the insurance site confirming participation by the vendor.

Although not critical to the operation of the inventive principles, it is preferred that after selecting the product or service that the customer wishes to purchase from the vendor's site, the customer is actually transported to the third-party site, rather than merely viewing a message at the vendor's site, in order to avoid the possibility that a dishonest vendor could display a counterfeit “site verified” message on the vendor's web site. Other approaches are of course possible. After confirming that the web site is verified, the customer can return to the vendor's web site by clicking on an appropriate link 205.

In addition to verifying that the vendor's site participates, the phone-card payment facilitation site may query the customer on the supplier of the phone card 206 to determine if it is supported as well.

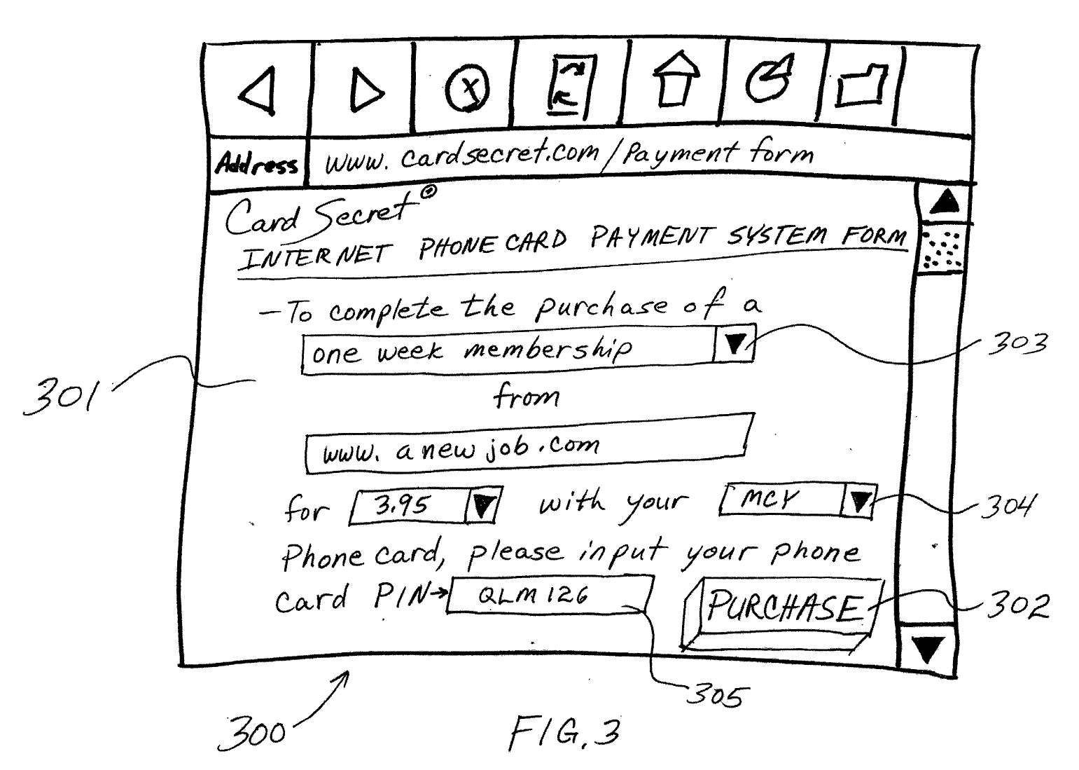

Assuming that the vendor's site has a financial affiliation with the phone-card payment web site, and the customer has a pre-paid phone card that is also supported, the customer would navigate to an on-line purchase page such as the one in FIG. 3. This form can be provided either by navigating through the phone-card payment facilitator logo 102 displayed on the vendor's web site (i.e., by navigating to the site of FIG. 2 and selecting option 204) or by directly navigating to an affiliated web site from the phone-card payment site as listed in FIG. 203a. In any event, an on-line purchase form preferably includes various fields for which the customer must provide input, namely the purchase selection, the manufacturer of the pre-paid phone card 304 that the purchase would be charged to, and the PIN code displayed on the phone card 305.

In one embodiment, some of the purchase information 301 can be stored on the customer's computer as a “cookie” and used to automatically prepopulate portions of the on-line purchase form 300, thus simplifying the entry of this information. Alternately, an additional service such as anonymity may be provided at this point, which would remove all “cookies” from the purchaser's web navigating experience, thus allowing anonymous browsing of web sites from the purchaser's computer. As the pre-paid phone card does not require proof of the user's identity, this advantage can be carried forward to the Internet browsing experience by allowing a person the opportunity to, for instance, search for a new job on the Internet from their employer's computer, without leaving any trace of their search, which could jeopardize their current job. From this form, the customer may enact the transaction by selecting a purchase icon 302.

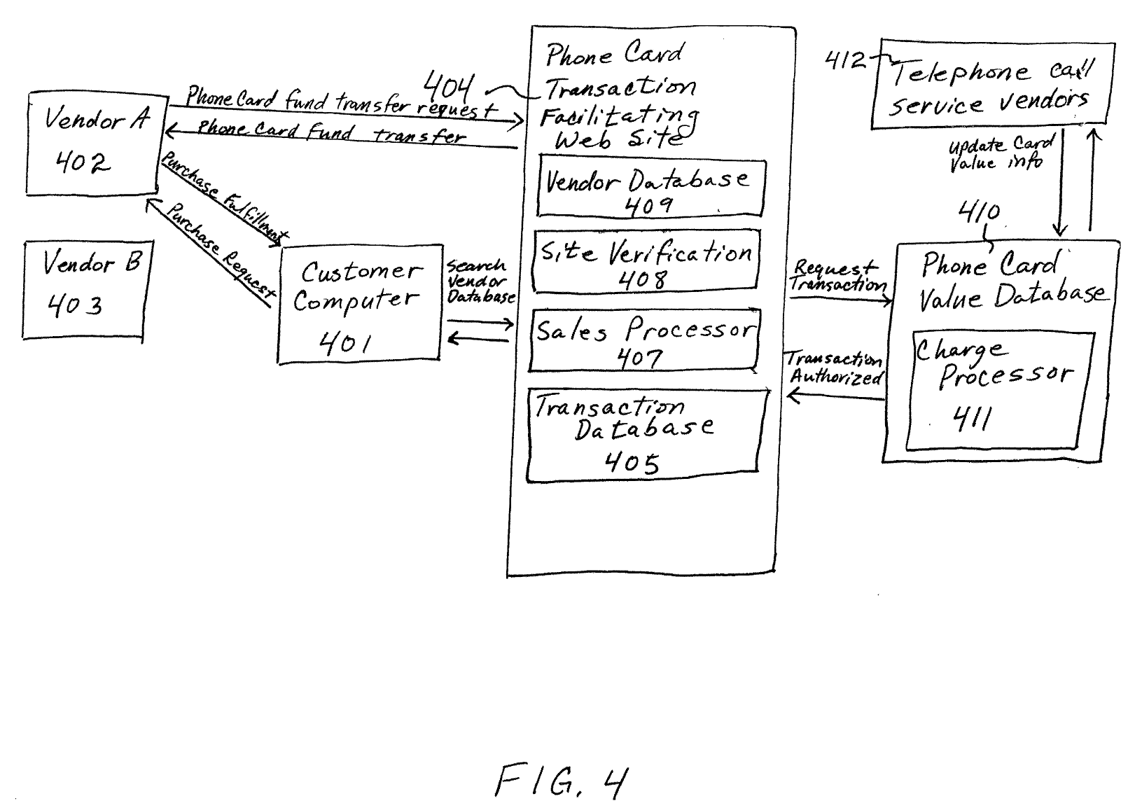

FIG. 4 shows in block diagram form a system employing various principles of the present invention. As shown in FIG. 4, a customer's computer 401 navigates to one or more vendor web sites 402 and 403 to make purchases of goods, services, or information. (It will be appreciated that these web sites can be located on physically separated machines or on the same machine). A phone-card payment facilitating web site 404 operated by a third party includes a site verification function 408 and a vendor database 409 containing information regarding web sites that participate in this payment method, which operates as described above. Additionally, a sales processing function 407 stores transaction information into a transaction database 405. Such transaction records may be transmitted to the receiving parties once for each transaction, or they may be batched into groups and periodically transmitted (e.g., once per day or so).

Transactions take place when the customer 401 selects a product or service from a vendor site 402 and requests a pre paid phone-card payment option on the sales transaction page of the vendor website. Upon receiving the purchase request, the phone-card payment facilitation site will prompt the purchaser for their phone card manufacturer information and Personal Identification Number. This data is then transmitted to the phone card value database 410 and evaluated to determine whether the card carries adequate value to complete the transaction. Pre paid phone cards commonly have monthly charges of approximately 10% of their value that will cause them to eventually expire. Also, there is no visible evidence on a card if its value has been depleted by either age or use for phone calls. Assuming the phone card has adequate value to complete the transaction, a charge processor 411 in the phone card value database 410 will reduce the remaining value of the card for the transaction, and make the updated card value information available to other participating vendor websites and phone call vendors 412.

Transaction data 405 is preferably used by the vendor site to confirm that a new customer has made payment for goods or services (i.e., to prevent fraud on the part of the consumer) and to compare to payments received from the phone card sales companies which may compensate the vendor sites for fulfilling sales orders. In one embodiment, as soon as the vendor receives confirmation of payment from the customer, the vendor site will issue a password directly to the customer for a single transaction or limited time access to information from the site. Other variations are of course possible.

The phone-card payment facilitating web site can charge a fee (e.g., 5%) for each transaction to either or any of the parties involved. It is possible to charge different amounts to different vendor sites and phone card companies. It is possible for a vendor site to charge customers a higher price for services when utilizing this payment method to offset the costs incurred by phone card companies of printing, distributing, and retailing pre-paid phone cards. The added value to the customer of limited financial exposure and a large degree of anonymity could justify the greater retail price. This safer payment method may benefit the consumer, and also increase business for vendor web sites. Additionally, the vendor database 203a and 207 has inherent value as a sales promotions vehicle, and may warrant charging a fee or reduced cost for services from the vendor websites in exchange for the visibility afforded the site from their inclusion in the phone-card payment system provider.

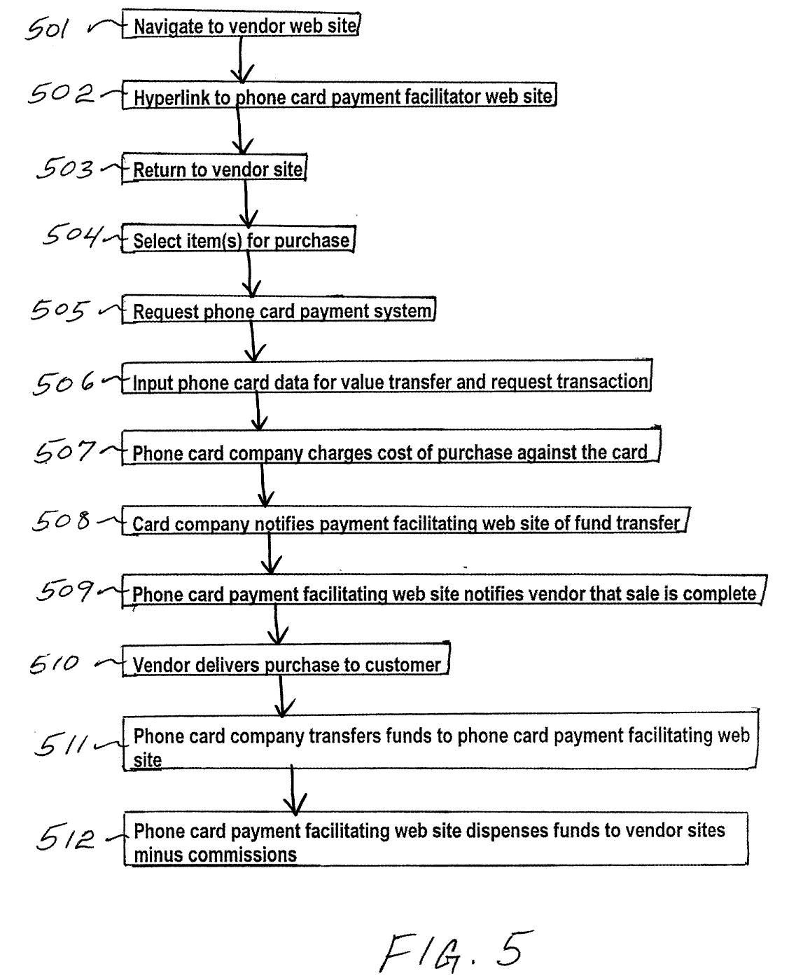

FIG. 5 shows various steps that can be carried out to implement aspects of the present invention. Although not explicitly shown in FIG. 5, it is assumed that one or more vendor web sites execute an agreement with a third-party phone-card payment facilitator that agrees to coordinate payments from phone card providing companies in exchange for their web services or products, and permits the phone-card payment facilitating company's branded logo to appear on the vendor's website.

Beginning in step 501, an Internet customer navigates using a web browser to a vendor's web site. In step 502, the customer decides to verify the vendor's participation in the phone-card payment facilitator program by navigating to the phone-card payment facilitator's web site, preferably by clicking on a branded hyperlink logo that indicates that a third party phone-card payment facilitator has agreed to coordinate purchases made from the site with selected phone card manufacturers. After verifying participation, in step 503 the customer returns to the vendor's web site. (Steps 502 and 503 are optional and can be left out).

In step 504, the customer places an order at the vendor's web site by filling in the necessary information required to indicate selection of information, goods or services. In step 505 the customer selects the pre paid phone card payment option to complete the transaction. This is accomplished by following a prompt on the vendor's site that hyperlinks the customer to the phone-card payment facilitator's site. Then, in step 506, the customer inputs the necessary card manufacturer information and the Personal Identification Number of the phone card into an on-line payment form to request authorization of their phone card and charge the cost of the vendor's services against the remaining value and requests the purchase. (Note that although the identification numbers are referred to as “personal,” the cards are generally purchased anonymously, such as at an airport or train station, and are thus untraceable to a particular person). At step 507, the phone card company charges the purchase against the value of the card. This transaction conventionally occurs by debiting a pre-stored value associated with the account number on the card. In certain variations, however (e.g., smart cards), the value may be debited directly from the card itself.

In step 508, the phone card company informs the phone-card payment facilitator that a charge has been completed, and thus the purchase may be authorized. In step 509, the phone-card payment company notifies the vendor website that the transaction has been completed and prompts the vendor website to fulfill the order to the customer. For step 510, the vendor web site will deliver the customer's purchase. In step 511, the phone card sponsor, manufacturer, or originator transfers funds from sales to the phone-card payment facilitator. In step 512 the phone-card payment facilitator dispenses funds to the vendor web sites minus commissions.

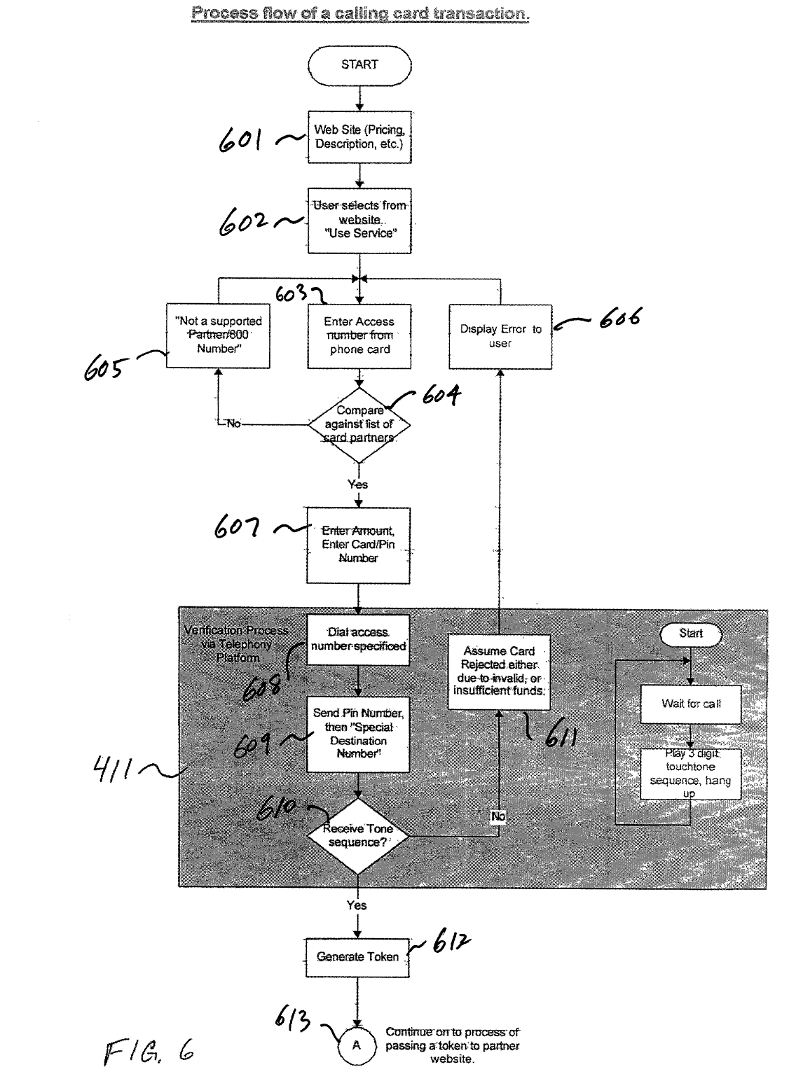

FIG. 6 depicts a flowchart showing various details of one possible purchase verification process that can be carried out through the use of a telephony platform. It also illustrates additional details of the Charge Processor 411. To execute an online request for a sales transaction, in one embodiment a phone card payment facilitating website operator initiates a process to verify and debit the customer's phone card. In step 601, the user visits a web site and selects products, services, or related information along with corresponding prices and descriptions. In step 602, the user selects a payment mechanism corresponding to a pre-paid debit card, such as a telephone calling card. In step 603, the user enters the access number from the phone card. In step 604, the information is compared to a list of card partners and, if the card is not one that is supported, an error message is generated in step 605. Otherwise, in step 607 the amount of the purchase and card/PIN number is entered.

Steps 608 through 611 illustrate a verification sub-process using a telephony platform, which can be executed by Charge Processor 411 in computer 404 of FIG. 4. In step 608, the specified access number is dialed. Utilizing information supplied by the customer, the process is initiated by placing a telephone call to the customer's phone card company operator (“A leg”). When a connection is made with the phone card company's calling card platform, the customer-supplied phone card number and the PIN are transmitted with touch-tone digits. Next, the process sends the phone card company an agreed-upon special phone number representing the dollar designation to be charged (one that is not in the normal dialing plans, i.e., 999-123-0010 could represent $10, while 999-123-0020 could represent $20, etc.). When the card operator receives this dialing pattern, its calling card platform will debit the user's card for the agreed-upon value, and also place an outbound call translating the special number received to a pre-defined phone number of the phone card facilitating website to be received by a telephony box designated for inbound calls. The telephony box will answer the call, and connect the inbound and outbound portions of the call (commonly referred to as the “A leg” and the “B leg”). Next, the telephony box will respond by sending a sequence of digits. The original outbound connection (“A leg”) from the phone card payment facilitating website will receive the digits played back, thus confirming that the card operator has debited the customer's phone card.

Thus has been described a system and method that allows consumers to purchase over the Internet online information, goods and services by applying pre-paid debit cards such as those utilized by the telephone industry. It will be appreciated that the inventive principles can be applied in a wireless environment, such that purchases can be made from cellular telephones or other wireless devices (e.g., Personal Digital Assistants), and among a larger or smaller number of computers than those illustrated herein. Reference numerals in the appended method claims identifying steps are for convenience only and are not intended to imply a necessary ordering of the steps. It is apparent that the method steps of the invention may be practiced in a different ordered sequence from that illustrated without departing from the scope of the invention. It is, therefore, to be understood that within the scope of the appended claims the invention may be practiced otherwise than as specifically described.

1. A system for facilitating purchases made over the Internet between a customer and a vendor, the system comprising:
a vendor web site through which the customer can make purchases, wherein the vendor web site consummates the purchases on the basis of a pre-paid anonymous debit card of the type utilized by the telephone industry to place telephone calls; and
a third-party payment facilitation computer linked to the vendor web site, wherein the third-party payment facilitation computer facilitates payment for the purchases by causing the purchases to be charged against the value of the pre-paid anonymous debit card.

2. The system of claim 1, further comprising a phone card computer system linked to the third-party payment facilitation computer, wherein the phone card computer system decreases the value of an account corresponding to the pre-paid anonymous debit card in response to purchases made by the customer through the vendor web site and the third-party payment facilitation computer.

3. The system of claim 1, wherein the vendor web site displays a logo that confirms the existence of an agreement between the third-party payment facilitation computer and the vendor to accept the pre-paid anonymous debit card.

4. The system of claim 3, wherein the logo comprises a hyperlink that permits the customer to navigate to a web site operated by the third-party payment facilitation computer.

5. The system of claim 4, wherein the web site operated by the third-party payment facilitation computer permits the customer to verify that the vendor participates in a phone-card payment facilitation system to cover the costs of customer purchases.

6. The system of claim 1, wherein the third-party payment facilitation computer permits the customer to input a phone card Personal Identification Number to effect the payment of a purchase.

7. The system of claim 1, wherein the third-party payment facilitation computer verifies the value of a customer's phone card by interfacing with an existing phone card system database prior to notifying the vendor web site that the sale is authorized.

8. The system of claim 1, wherein the third-party payment facilitation computer displays a list of vendor web sites that are affiliated with the third-party payment facilitation computer for the purpose of making purchases using pre-paid anonymous debit cards.

9. A system for facilitating purchases made over the Internet between a customer and a vendor, the system comprising a third-party phone-card payment facilitation computer, linked to a vendor computer and operated by a phone-card payment facilitator having an agreement with the vendor to coordinate payment transfer for purchases made by the customer from a web site operated by the vendor, wherein the phone-card payment facilitation computer arranges payment to the vendor from a phone card sponsor for purchases made through the web site operated by the vendor.

10. The system of claim 9, wherein the third-party phone-card payment facilitation computer arranges for the payment to vendor web sites by dialing a telephone number to connect to a phone card sponsor computer and authorizing the purchase through the phone card sponsor computer.

11. The system of claim 9, wherein the third-party phone-card payment facilitation computer permits the customer to verify the existence of the agreement between the vendor and the phone card payment facilitator.

12. The system of claim 9, wherein the third-party phone-card payment facilitation computer permits the customer to enter a phone card personal identification number to initiate payment for purchases.

13. The system of claim 9, wherein the phone-card payment facilitation computer permits the customer to view a listing of a plurality of participating vendor web sites and phone card sponsors.

14. A vendor computer that permits a customer to make purchases through a web page hosted on the vendor computer, wherein the web page displays a logo that identifies a third-party phone-card payment facilitation computer that has agreed to coordinate purchases requested by the customer through the vendor computer, wherein the logo comprises a hyperlink to a phone-card payment facilitation web site, and wherein upon activation of the hyperlink, the customer is able to verify that the third-party phone-card payment facilitation computer coordinates purchases using the customer's pre-paid anonymous phone debit card.

15. A system including the vendor computer of claim 14, and further including a second vendor computer that also permits the customer to make purchases through a second web page hosted on the second vendor computer, wherein the second web page displays the same logo that identifies the third-party phone-card payment facilitator.

16. A method for facilitating purchases requested by a customer over the Internet through a vendor web site, comprising the steps of:
(1) representing on the vendor web site that the purchases requested by the customer may be paid for by charging the purchase against the value of the customer's prepaid anonymous phone card;
(2) facilitating a purchase from the vendor web site using the pre-paid anonymous phone card; and
(3) arranging payment for the customer's purchases to be transferred from the prepaid anonymous phone card to operators of the vendor web site.

17. The method of claim 16, further comprising the step of displaying to the customer in response to a customer inquiry for a specified product category a list of vendor web sites that are represented by the third-party phone-card payment facilitation web site in arranging payment for purchases with phone card manufacturers.

18. The method of claim 16, wherein step (2) comprises the step of dialing out from a facilitating computer to a telephone computer that stores information regarding credits available on the pre-paid anonymous phone card in order to authorize the purchase.

19. The method of claim 16, wherein step (2) comprises the step of the customer entering a card number and personal identification number associated with the pre-paid anonymous phone card into a web page form.

20. The method of claim 16, wherein step (2) comprises the step of transmitting a touch-tone code representing an amount of a purchase to a computer that verifies that the amount of the purchase can be covered by credit available on the pre-paid anonymous phone card.
